(19) United States
(12) Patent Application Publication
(10) Pub. No.: US 2025/0042472 A1
(43) Pub. Date: Feb. 6, 2025

(54) SYSTEM AND METHOD FOR MODIFYING VEHICULAR STEERING GEOMETRY GUIDED BY INTELLIGENT TIRES

(71) Applicant: VOLVO TRUCK CORPORATION, Gõteborg (SE)

(72) Inventor: Chidambaram SUBRAMANIAN, Jamestown, NC (US)

(73) Assignee: VOLVO TRUCK CORPORATION, Göteborg (SE)

(21) Appl. No.: 18/717,206

(22) PCT Filed: Dec. 7, 2021
(86) PCT No.: PCT/US2021/062252

§ 371 Date: Jun. 6, 2024

(51) Int. Cl. B62D 17/00; B62D 6/00

(52) U.S. Cl. CPC B62D 17/00; B62D 6/00

(57) ABSTRACT

Systems, methods, and computer-readable storage media for a vehicle which controls wheel alignment using a closed loop feedback coupled with one or more machine learning algorithms. The system receives an optimization directive for the vehicle, and also receives from at least one tire sensor while the vehicle is in transit, a tire forces signal. The system estimates, based at least in part on the tire forces signal, at least one aspect of vehicle performance, and executes a machine learning model, where the inputs to the machine learning model are the optimization directive and the at least one aspect of vehicle performance. The outputs of the machine learning model include a desired wheel alignment signal, and the system modifies, via a wheel alignment controller, a wheel alignment of the vehicle based at least in part on the desired wheel alignment signal.

### BACKGROUND

### 1. Technical Field

The present disclosure relates to vehicular steering geometry, and more specifically to modifying a vehicle's steering geometry based on data from sensors located in the vehicle's tires.

### 2. Introduction

Modern vehicles have superior control systems in the chassis in order to improve the performance and safety of the vehicle. However, the performance of the vehicle (such as fuel economy, vehicle stability, and tire wear) is highly dependent on the wheel alignment/steering geometry (such as camber and toe-in) for a specific application, driver behavior, and/or a specific driving cycle (such as acceleration versus steady velocity, maneuvering style, and/or braking style). The optimum steering geometry values to obtain necessary performance and meet legal regulations can therefore vary based on the driver, where the vehicle is operating, and what the vehicle is being used for.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving, at a processor aboard a vehicle, an optimization directive for the vehicle; receiving, at the processor from at least one tire sensor while the vehicle is in transit, a tire forces signal; estimating, via the processor and based at least in part on the tire forces signal, at least one aspect of vehicle performance; executing, via the processor, a machine learning model, wherein inputs to the machine learning model comprise the optimization directive and the at least one aspect of vehicle performance, and wherein outputs of the machine learning model comprise a desired wheel alignment signal; and modifying, via a wheel alignment controller, a wheel alignment of the vehicle based at least in part on the desired wheel alignment signal.

A vehicle configured to perform the concepts disclosed herein can include: at least one wheel; at least one tire attached to the at least one wheel; at least one tire sensor associated with the at least one wheel; a wheel alignment controller configured to modify an alignment of the at least one wheel; a processor; a non-transitory computer-readable storage medium having instructions stored which, when executed by the processor, cause the processor to perform operations comprising: receiving an optimization directive for the vehicle; receiving, from the at least one tire sensor while the vehicle is in transit, a tire forces signal; estimating, based at least in part on the tire forces signal, at least one aspect of vehicle performance; and executing a machine learning model, wherein inputs to the machine learning model comprise the optimization directive and the at least one aspect of vehicle performance, and wherein outputs of the machine learning model comprise a desired wheel alignment signal; and wherein the wheel alignment controller modifies a wheel alignment of the vehicle based at least in part on the desired wheel alignment signal.

A non-transitory computer-readable storage medium configured as disclosed herein can have instructions stored which, when executed by a computing device, cause the computing device to perform operations which include: receiving an optimization directive for the vehicle; receiving, from at least one tire sensor while the vehicle is in transit, a tire forces signal; estimating, based at least in part on the tire forces signal, at least one aspect of vehicle performance; executing a machine learning model, wherein inputs to the machine learning model comprise the optimization directive and the at least one aspect of vehicle performance, and wherein outputs of the machine learning model comprise a desired wheel alignment signal; and modifying, via a wheel alignment controller, a wheel alignment of the vehicle based at least in part on the desired wheel alignment signal.

### BRIEF DESCRIPTION OF THE DRAWINGS

FIG. 1 illustrates an example system embodiment;

FIG. 2 illustrates an example tire and tire sensors;

FIG. 3 illustrates exemplary forces associated with a tire;

FIG. 4 illustrates an example of steering geometry being manipulated by wheel alignment signals;

FIG. 5 illustrates an example method embodiment; and

FIG. 6 illustrate an example computer system.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

“Intelligent tires” are tires which have sensors placed inside the tire to provide different real-time information about the tire-road interaction. These sensors can provide data regarding the tire normal load, tire wear, friction, slip (lateral and longitudinal), wheel alignment, steering geometry, hydroplaning, tire health, etc.

The performance of a vehicle (e.g., fuel economy, stability and/or tire wear) is highly dependent on the wheel alignment/steering geometry (camber and toe-in) for a specific application (e.g., driving in the suburbs v. highways driving), and for a specific driving cycle (e.g., acceleration, maneuver style (rapid or smooth), and braking). The steering geometry control system disclosed herein can modify, as the vehicle is in motion, the vehicle steering geometry to obtain better performance for a given application, driving cycle, or preference of a driver/passenger. Sensors within the tires can then detect how this modification to the steering geometry changed the forces acting on the wheel and provide that data to a reinforcement learning algorithm. For example, when the steering geometry control system makes modifications to the vehicle steering geometry, the sensors within the vehicle's intelligent tires provide feedback data to a reinforcement learning algorithm, informing the steering geometry model if the previous predictions which modified the steering geometry were correct or incorrect. This feedback data “closes the loop,” and allows the control system's algorithm to modify how and when the geometry is adjusted to achieve the desired results in the tires themselves.

A non-limiting example of the general process and system operate as follows: (1) collect past/example steering geometry data; (2) perform a sensitivity analysis using the steering geometry data; (3) use the output of the steering geometry data sensitivity analysis to create a machine learning steering geometry model (a neural network); (4) collect past/example steering geometry control signals and past/example tire data; (5) perform a sensitivity analysis using the steering geometry control signals and tire data; (6) use the output of the control signals/tire data sensitivity analysis to create a reinforcement learning algorithm (a neural network); (7) load the machine learning steering geometry model and the reinforcement learning algorithm into computer-readable storage media aboard a vehicle; (8) operate the vehicle, changing the steering geometry according to application, driving cycle, and/or environment as dictated by the machine learning steering geometry model; (9) capture tire sensor data and provide that data to the reinforcement learning algorithm with the predicted outcomes of the machine learning steering geometry model; (10) modify the machine learning steering geometry model based on the output of the reinforcement learning algorithm; and (11) continue steps (8)-(10) throughout the life of the vehicle.

The sensors within the intelligent tires can be any type of sensor which provide information about the position of the tire, the forces acting on the tire, pressure within the tire, sound level within the tire, and/or strain of the tire. The tire sensors can be located within the tire and/or located on the rim of the wheel to which the tire is attached. One exemplary sensor which can be located within the tire is an accelerometer. Preferably, the accelerometer is a three dimensional accelerometer (X—longitudinal, Y—lateral, and Z—vertical, axes) located in the inner side of the tire as a strip along the Z (vertical) direction, though the type and location of the accelerometer can vary. This exemplary accelerometer can output data associated with each respective dimension (X, Y, and Z), where that data would vary based on the wheel alignment for a consistent application of force. Another exemplary sensor is an optical sensor. The optical sensor can capture the deflection in the contact patch of the tire at multiple lateral points on the tire, thereby capturing deflection differences at different locations within the tire. These deflection differences can then be output by the sensor. Yet another exemplary sensor is a strain gauge sensor. This exemplary sensor could be inserted to run longitudinally on the tire circumference, or laterally to measure the strain at the contact patch, and capture the strain on the tire while rolling.

The above-mentioned tire behavior captured by the sensors (acceleration, movement, deflection, strain, jerk, etc. at the contact patch or throughout the tire) is a function of several parameters (e.g., vehicle state, tire dynamics, and environmental conditions). The sensitivity of the tire performance to the respective steering geometries can vary. Vehicles and systems configured as described herein can use a machine learning steering geometry model to predict how the wheel alignment of one or more tires of the vehicle should be modified to achieve a desired tire performance. The machine learning steering geometry algorithm can be built using, for example, methods such as random trees, bagged trees, shallow neural networks, deep neural networks, and recurrent neural networks. The prediction from the machine learning steering geometry algorithm can be sent to a controller which causes the change in wheel alignment geometry, the sensors in the tire report back the actual forces on the wheel, and the machine learning steering geometry algorithm can then be modified to account for predicted change v. actual change. For each different type of sensor there can be a neural network trained to identify the wheel alignment based on the data from that sensor. If the tires contain more than one type of sensor, a neural network can be configured to identify wheel alignment based on the data from the combination of the sensors and/or individual sensors within the tires.

The data collected from tire sensors can provide many factors/parameters regarding the vehicle performance, factors which can be used in determining if the changes by the steering geometry controller are effective. These factors can then be used to update the steering geometry model which provides commands to the steering geometry controller. To determine which factors should be used in updating the steering geometry model, a sensitivity analysis is performed. The sensitivity analysis determines which factors affect the sensor readings in the tire, and to what amount. For example, a sensitivity analysis could reveal that an accelerometer was used and the measured vibration from that accelerometer on the inner liner of the tire is highly sensitive (have an impact above a predetermined level) to factors including vehicle load, vehicle speed, tire slip, tire pressure, wheel alignment, and road surface-factors which are either directly or indirectly determined from the accelerometer data. The sensitivity analysis can be generated before the system is in active use (e.g., based on data collected and analyzed before an individual vehicle configured with the steering geometry model, reinforcement learning algorithm, and steering geometry controllers disclosed herein leaves a manufacturing plant). Once the vehicle is in use, the steering geometry model generated from the sensitivity analysis can be uploaded into a vehicle and can be further updated via a reinforcement learning algorithm. This reinforcement learning can rely on the data from the tire sensors within the vehicle, and can modify the model's code based on how the tire sensor data indicates changes to the steering geometry actually effect the forces within the tire. In some cases, this modification can require changing the weighting of a particular factor, whereas in other cases this modification can require overwriting code within the vehicle's computer memory associated with the steering geometry model.

The machine learning steering geometry model can be, for example, an artificial neural network created using known vehicle drive cycles, driving styles, and steering geometries. This neural network can then be converted to computer executable code as a machine learning steering geometry model, then deployed on a vehicle. When in operation, the vehicle can execute a reinforcement learning algorithm (also an artificial neural network), where inputs from the vehicle (from vehicle sensors) can allow the reinforcement learning algorithm to determine if the predictions being made by the machine learning steering geometry model (and executed by the steering geometry controller and actuators) are accomplishing the desired goals. If not, the reinforcement learning algorithm can modify the machine learning steering geometry model. In some configurations, this modification can be a change in the weights associated with a particular factor being used by the machine learning steering geometry model (for example, changing how much a particular variable affects the desired steering geometry, or changing how far a given component is moved by an actuator when a given threshold is detected).

The reinforcement learning algorithm can identify a projected outcome of the steering geometry model, identify what aspects of the steering control geometry were previously modified by the controller, and determine from the tire data which aspects of those changes meet (or failed) the projected expectations. Each time an expectation is met, the reinforcement learning algorithm can reinforce the existing steering geometry model (for example, adding a point to a score for the existing steering geometry model). Likewise, if the steering geometry model erred, the reinforcement learning algorithm can weaken the existing steering geometry model (for example, removing a point from the score of the existing steering geometry model). If the score were to receive a sufficiently negative score that the steering geometry model can no longer be trusted, this information can be passed on to an owner or user of the vehicle, with the goal of initiating servicing of the vehicle to update the steering geometry model. If the vehicle is capable of wireless/remote updates, a low score could also initiate a wireless update of the model. The reinforcement learning algorithm can also self-modify over time. If, for example, the algorithm identifies that certain modifications to the steering geometry model have little or no effect on the forces within the tire, the reinforcement learning algorithm can cease to modify those aspects of the machine learning steering geometry model.

While both the steering geometry model and the reinforcement learning algorithm can be installed within vehicles in a factory form, overtime they can evolve to be specific to the vehicle itself. For example, as the vehicle sensors for a vehicle collect data and the reinforcement learning algorithm analyzes that data, the reinforcement learning algorithm within a vehicle can modify the steering geometry model specifically for that vehicle. Likewise, over time the reinforcement learning algorithm can adapt and self-modify, producing more accurate predictions of how changes to the steering geometry model will result in changes to the actual steering geometry, resulting in a vehicle specific reinforcement learning algorithm.

The system can use a PID (Proportional-Integral-Derivative) controller to offset any calibration and accurately control the wheel alignment. This avoids the need for any additional sensors apart from the smart tire sensors to accurately measure wheel alignment and provide feedback. That is, using the disclosed systems and mechanisms can reduce the number of sensors required to obtain optimal wheel alignment for a particular set of circumstances. The desired wheel alignment values can also be obtained from neural network models which provide outputs based on intelligent tire inputs. Using the steering-suspension kinematics and compliances, the system can use state estimators for this PID control to reduce overshoot and reduce settling time, as well as to ensure that the drivability of the vehicle is not affected.

The feedback loop for the reinforcement learning algorithm relies on the tire forces detected by the intelligent tire sensors, and the tire forces are communicated to the reinforcement learning algorithm as signals from the intelligent tire sensors. Additional data from the vehicle, collected by the vehicle sensors, which can be used by the machine learning steering geometry model and/or the reinforcement learning algorithm can include data regarding the vehicle velocity, vehicle acceleration, wheel speeds, steering angle, throttle activation, brake pedal activation, axle load, position (via Global Positioning System (GPS)), suspension articulation data, tire pressure(s), road surface type over which the vehicle is currently traversing, and/or current steering input. Other exemplary data which can be collected could include slip data for the various wheels, braking capacity, angle of ascent/descent, general engine data, road conditions (wet, dry, icy, etc.), acceleration/deceleration patterns over a period of time, and/or any other data conveyed via the Controller Area Network (CAN) bus within a vehicle.

Any combination of the collected vehicle data can be input into a reinforcement learning algorithm executed by a processor of the vehicle. The reinforcement learning algorithm is a machine learning algorithm which rewards desired behaviors and/or punishes undesired ones. In general, a reinforcement learning agent perceives and interprets its environment, takes actions and learns through past data. In systems configured as disclosed herein, a reinforcement learning algorithm is used to refine the recommendations the steering geometry model makes to optimize steering geometry. More specifically, the system uses the tire forces identified by the intelligent tire sensors, and uses that data to improve fuel economy, ride comfort, traction, and/or tire wear. That would be utilized to provide a feedback (reward or punishment) to the reinforcement learning algorithm so that over time the system learns and optimizes the desired wheel alignment output. The reinforcement learning algorithm can also be a neural network, configured in a similar way to other neural networks described herein. The reinforcement learning algorithm can also be part of an overall steering control model which identifies the current vehicle status, such as driving cycle or vehicle application, and selects an “optimal” steering control configuration for the current vehicle status. Examples of driving cycles of the vehicle can include “transient” (where the vehicle is undergoing many changes, typical in stop and go traffic or off-roading), or “modal” (where the vehicle is going long periods of time at a constant speed). Examples of vehicle applications can include if the vehicle is being used to transport goods, ferry passengers, drive in an urban environment, drive off-road, etc.

Preferably the vehicle is equipped with actuators to adjust steering geometry components. The wheel alignment output of the machine learning steering geometry model can be transmitted to the steering geometry controller which controls one or more actuators corresponding to the respective tires, such that the actuators adjust the vehicle steering geometry while the vehicle is in operation. In some configurations, where the vehicle is not configured to auto-adjust via actuators while operating, the outputs of the machine learning steering geometry model can be presented to the driver or to a technician, who can then make manual adjustments to the vehicle at their judgment. Such output can, for example, be displayed on the vehicle dashboard, via a smartphone application, or by any other effective vehicle-to-human communication mechanism.

When training the neural networks described herein (the machine learning steering geometry model and the reinforcement learning algorithm), the outputs of the respective sensitivity analyses, as well the sensitivity analyses training data, can then be used to construct a respective neural network. For example, the correlations and test data associated with the sensitivity analysis can be input into Python, MatLab®, or other development software configured to construct neural network based on factor-specific data. Depending on the specific scenario, users can adjust the neural network construction by selecting from optimization methods including (but not limited to) the least-squares method, the Levenberg-Marquardt algorithm, the gradient descent method, or the Gauss-Newton method. The neural network can make predictions of the optimal wheel alignment/steering geometry given input variables corresponding to the same data which were used to train the neural network. The neural network can then be converted to machine code and uploaded into memory, where upon execution by a processor the neural network operates as a machine learning model.

Exemplary data for the sensitivity analyses can include: (1) the known feature data, (2) the corresponding, known driving cycles, (3) the corresponding, known vehicle applications, and (4) known steering geometry component values, (5) known wheel alignment values, and/or (6) tire forces, which can be compared via a sensitivity analysis, resulting in correlations between the respective data.

Systems configured as disclosed herein may be “closed loop” systems, which rely on intelligent tires to collect feedback for the control system, and which allows the desired geometry to be attained. For example, an “open loop” system can rely on linear interpolation, e.g., where a 0 volt signal indicates a 0 degree camber, and a 5 volt signal indicates a 3 degree camber, the intermediate values are determined linearly. By contrast, in systems configured as disclosed herein, the control system can receive a signal to set the camber at 1 degree. The system will change the voltage and then collect feedback from the tire sensor indicating if the camber is actually 1 degree. If not, the system will continue changing the voltage until the required camber is achieved. In this manner the actuator mechanism gets the signal from steering geometry controller and modifies the physical components as necessary. The steering geometry model then collects data from the intelligent tires sensors and sends updated signal(s) to the controller. The collected data from the intelligent tires provides feedback to the steering geometry model to select the optimum wheel alignment for a particular application, driving cycle, and/or user instructions. In this manner, a vehicle equipped with intelligent tires can provide real-time information about the tire-road interaction (e.g. tire normal load, tire wear, friction, slip (lateral and longitudinal), wheel alignment, steering geometry, tire noise, hydroplaning, tire health etc.) to change the steering geometry and obtain optimal wheel alignment.

Over time, the wheel alignment values stored within the machine learning steering geometry model may need to be modified. For example, a vehicle's steering geometry model may have identified that a camber of 5 degrees is desired, and in the past 5 volts resulted in that 5 degrees of camber, as verified by the tire sensors. However, the vehicle has recently hit a bump and now 5 volts only results in 3 degrees of camber. The reinforcement learning algorithm can receive the actual camber from the tire sensors and the desired camber from the steering geometry model, identify the discrepancy, and modify the steering geometry model. In practice it may take several iterations for the steering geometry model and the reinforcement learning algorithm to reach equilibrium, at which point the system can stay consistent until another bump is hit (or other event occurs). The reinforcement learning algorithm can also have a level of sensitivity, such that it doesn't modify the steering geometry model until the difference between the predicted geometry and the actual geometry exceeds a predetermined threshold.

While the steering geometry model and the reinforcement learning algorithm are described herein as separate, in practice they can be executed by a common processor using separate threads or other means for executing multiple pieces of software simultaneously.

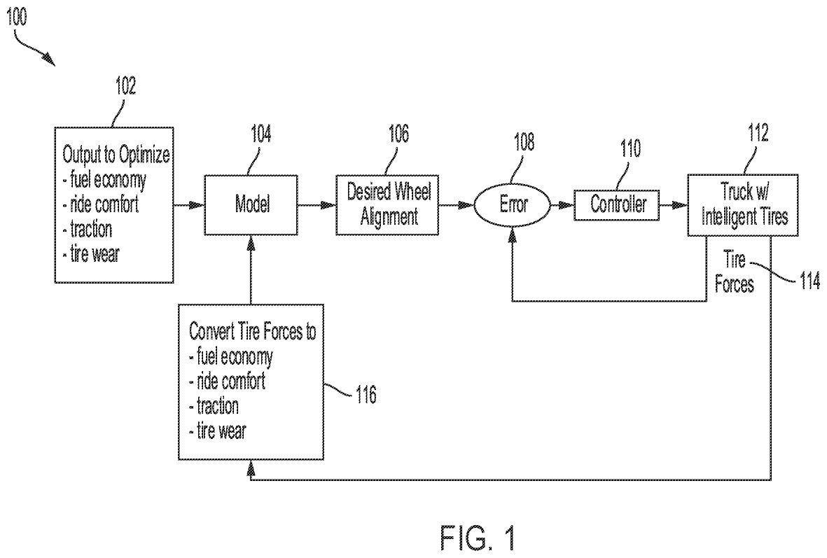

FIG. 1 illustrates an example system embodiment 100. As illustrated, a user (i.e., driver or passenger of a vehicle, or a fleet manager) can select various aspects 102 of vehicle performance to optimize. For example, the user can select to optimize fuel economy, ride comfort, traction, tire wear, and/or any combination thereof. That desired aspect of vehicle performance is provided to a steering geometry model 104, which outputs a desired wheel alignment 106. The desired wheel alignment 106 is communicated (usually via electrical signals within the vehicle) to a steering geometry controller 110. The steering geometry controller incites actuators to move components of the steering geometry according to the desired wheel alignment 106. A vehicle (in this case a truck) with intelligent tires 112 can capture, via sensors within the tires, tire forces 114, and communicate those tire forces 114 back to the controller 110, establishing the difference as known error 108. The tire forces 114 can also be converted 116, via data specific neural networks, to measure aspects of fuel economy, ride comfort, traction, tire wear, and/or any combination thereof, allowing the model 104 to determine if optimization has been obtained. If not, the model 104 can be updated to move closer to that optimization. This process can continue as long as the vehicle continues to operate.

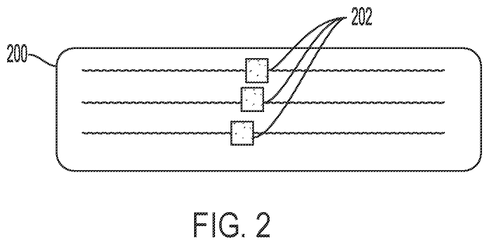

FIG. 2 illustrates an example tire 200 and tire sensors 202. In this example, the sensors 202 are slightly offset from one another along the inner side of the tire in a line along the Y direction, allowing each sensor to record slightly different versions of the data. In some configurations, this data can be averaged together, then communicated to the steering geometry model and the reinforcement learning algorithm. In other configurations, each piece of data can be respectfully communicated to the steering geometry model and the reinforcement learning algorithm.

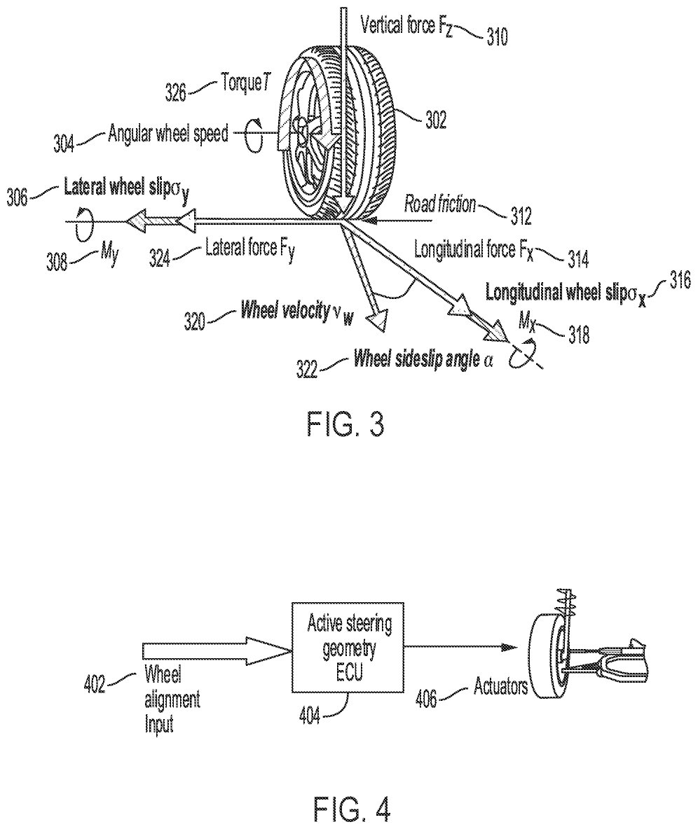

FIG. 3 illustrates exemplary forces associated with a tire 302. As illustrated, exemplary forces can include: angular wheel speed 304, lateral wheel slip σ_{y} 306, lateral coefficient of friction M_{y} 308, vertical force F_{z} 310, road friction 312, longitudinal force Fₓ 314, longitudinal wheel slip σₓ 316, forward coefficient of friction Mₓ 318, wheel velocity v_{w} 320, and wheel sideslip angle α 322. The sensors within an intelligent tire can report one or more of any of such forces to the steering geometry model and/or the reinforcement learning algorithm, as required by a given configuration.

FIG. 4 illustrates an example of steering geometry within a vehicle being manipulated by wheel alignment signals. In this example, a wheel alignment input 402 is received from the machine learning steering geometry model, generally in the form of an electrical signal indicating how one or more of the steering geometry components should be configured. That wheel alignment input 402 is received by an active steering geometry ECU (Electronic Control Unit) 404, which is in electrical contact with actuators 406 which can modify the vehicle's steering geometry. The “active” aspect of this exemplary ECU 404 indicates that the steering control can be modified during vehicle operation. The ECU 404 receives the wheel alignment input 402 and, based on that input, transmits control signals to the actuators 406, causing the actuators to modify the vehicle's steering geometry.

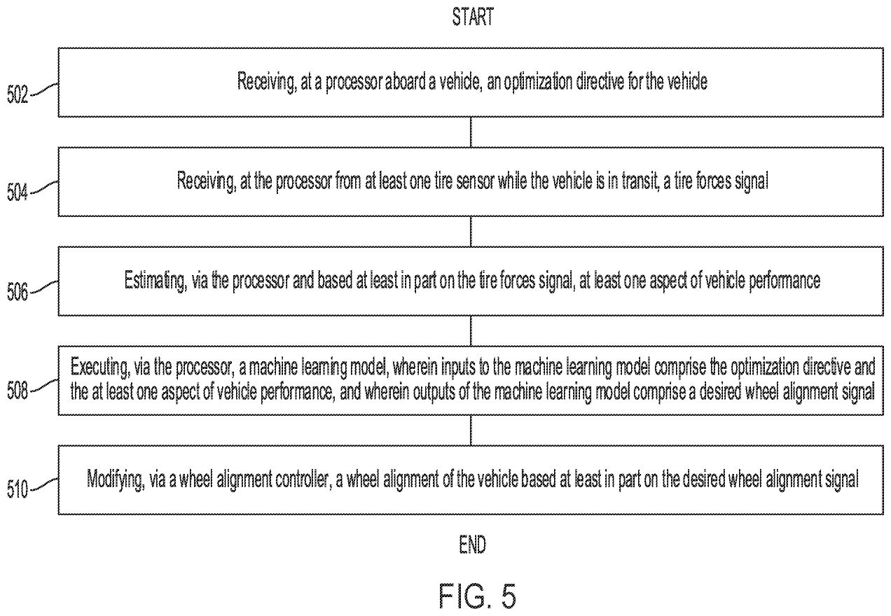

FIG. 5 illustrates an example method embodiment. As illustrated, the method can include receiving, at a processor aboard a vehicle, an optimization directive for the vehicle (502) and receiving, at the processor from at least one tire sensor while the vehicle is in transit, a tire forces signal (504). The system can estimate, via the processor and based at least in part on the tire forces signal, at least one aspect of vehicle performance (504) and execute, via the processor, a machine learning model, wherein inputs to the machine learning model comprise the optimization directive and the at least one aspect of vehicle performance, and wherein outputs of the machine learning model comprise a desired wheel alignment signal (506). The system can then modify, via a wheel alignment controller, a wheel alignment of the vehicle based at least in part on the desired wheel alignment signal.

In some configurations, the method can further include: receiving, at the wheel alignment controller, the tire forces signal; and calculating, at the wheel alignment controller, an error between a desired wheel alignment value associated with the desired wheel alignment signal and an actual wheel alignment value identified by the tire forces signal. In such configurations, the method can further include modifying the machine learning model based on the error.

In some configurations, the machine learning model is a reinforcement learning algorithm.

In some configurations, the at least one aspect of vehicle performance comprises at least one of: fuel economy of the vehicle while in transit, comfort level of the vehicle while in transit, traction of the vehicle while in transit, and rate of tire wear on tires of the vehicle while in transit.

In some configurations, the optimization directive is provided by one of a passenger or a driver of the vehicle.

In some configurations, the optimization directive comprises instructions to maximize at least one of: fuel economy of the vehicle while in transit, comfort level of the vehicle while in transit, traction of the vehicle while in transit, and tire wear on tires of the vehicle while in transit.

In some configurations, the machine learning model is generated by: performing a sensitivity analysis which identifies correlations between known values of vehicle data associated with the vehicle, known values of wheel alignment components, known driving cycles, and known vehicle applications; forming, via a computing device, a neural network using the correlations; and converting, via the computing device, the neural network to computer executable code, resulting in the machine learning model.

In some configurations, the machine learning model illustrated in FIG. 5 is a combination of the machine learning steering geometry model and the reinforcement learning algorithm disclosed herein. In other configurations, the machine learning model comprises only the machine learning steering geometry model or only the reinforcement learning algorithm.

In some configurations, the tire forces signal identifies: a vertical force on at least one tire of the vehicle; a lateral force on the at least one tire of the vehicle; and a longitudinal force on the at least one tire of the vehicle. In other configurations the tire forces signal can include distinct forces or combinations of other forces.

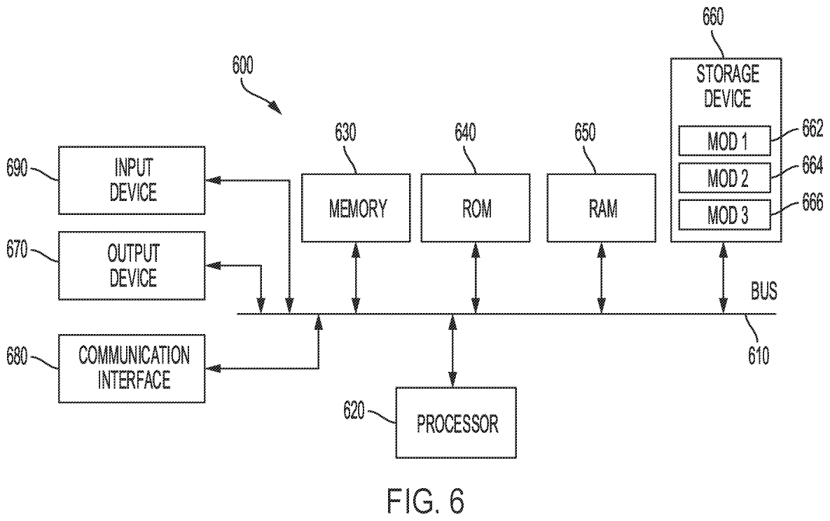

With reference to FIG. 6, an exemplary system includes a general-purpose computing device 600, including a processing unit (CPU or processor) 620 and a system bus 610 that couples various system components including the system memory 630 such as read-only memory (ROM) 640 and random access memory (RAM) 650 to the processor 620. The system 600 can include a cache of high-speed memory connected directly with, in close proximity to, or integrated as part of the processor 620. The system 600 copies data from the memory 630 and/or the storage device 660 to the cache for quick access by the processor 620. In this way, the cache provides a performance boost that avoids processor 620 delays while waiting for data. These and other modules can control or be configured to control the processor 620 to perform various actions. Other system memory 630 may be available for use as well. The memory 630 can include multiple different types of memory with different performance characteristics. It can be appreciated that the disclosure may operate on a computing device 600 with more than one processor 620 or on a group or cluster of computing devices networked together to provide greater processing capability. The processor 620 can include any general purpose processor and a hardware module or software module, such as module 1 662, module 2 664, and module 3 666 stored in storage device 660, configured to control the processor 620 as well as a special-purpose processor where software instructions are incorporated into the actual processor design. The processor 620 may essentially be a completely self-contained computing system, containing multiple cores or processors, a bus, memory controller, cache, etc. A multi-core processor may be symmetric or asymmetric.

The system bus 610 may be any of several types of bus structures including a memory bus or memory controller, a peripheral bus, and a local bus using any of a variety of bus architectures. A basic input/output (BIOS) stored in ROM 640 or the like, may provide the basic routine that helps to transfer information between elements within the computing device 600, such as during start-up. The computing device 600 further includes storage devices 660 such as a hard disk drive, a magnetic disk drive, an optical disk drive, tape drive or the like. The storage device 660 can include software modules 662, 664, 666 for controlling the processor 620. Other hardware or software modules are contemplated. The storage device 660 is connected to the system bus 610 by a drive interface. The drives and the associated computer-readable storage media provide nonvolatile storage of computer-readable instructions, data structures, program modules and other data for the computing device 600. In one aspect, a hardware module that performs a particular function includes the software component stored in a tangible computer-readable storage medium in connection with the necessary hardware components, such as the processor 620, bus 610, display 670, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 600 is a small, handheld computing device, a desktop computer, or a computer server.

Although the exemplary embodiment described herein employs the hard disk 660, other types of computer-readable media which can store data that are accessible by a computer, such as magnetic cassettes, flash memory cards, digital versatile disks, cartridges, random access memories (RAMs) 650, and read-only memory (ROM) 640, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 600, an input device 690 represents any number of input mechanisms, such as a microphone for speech, a touch-sensitive screen for gesture or graphical input, keyboard, mouse, motion input, speech and so forth. An output device 670 can also be one or more of a number of output mechanisms known to those of skill in the art. In some instances, multimodal systems enable a user to provide multiple types of input to communicate with the computing device 600. The communications interface 680 generally governs and manages the user input and system output. There is no restriction on operating on any particular hardware arrangement and therefore the basic features here may easily be substituted for improved hardware or firmware arrangements as they are developed.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method comprising:
receiving, at a processor aboard a vehicle, an optimization directive for the vehicle;
receiving, at the processor from at least one tire sensor while the vehicle is in transit, a tire forces signal;
estimating, via the processor and based at least in part on the tire forces signal, at least one aspect of vehicle performance;
executing, via the processor, a machine learning model, wherein inputs to the machine learning model comprise the optimization directive and the at least one aspect of vehicle performance, and wherein outputs of the machine learning model comprise a desired wheel alignment signal; and
modifying, via a wheel alignment controller, a wheel alignment of the vehicle based at least in part on the desired wheel alignment signal.

2. The method of claim 1, further comprising:
receiving, at the wheel alignment controller, the tire forces signal; and
calculating, at the wheel alignment controller, an error between a desired wheel alignment value associated with the desired wheel alignment signal and an actual wheel alignment value identified by the tire forces signal.

3. The method of claim 2, further comprising:
modifying the machine learning model based on the error.

4. The method of claim 1, wherein the machine learning model is a reinforcement learning algorithm.

5. The method of claim 1, wherein the at least one aspect of vehicle performance comprises at least one of: fuel economy of the vehicle while in transit, comfort level of the vehicle while in transit, traction of the vehicle while in transit, and rate of tire wear on tires of the vehicle while in transit.

6. The method of claim 1, wherein the optimization directive is provided by one of a passenger or a driver of the vehicle.

7. The method of claim 1, wherein the optimization directive comprises instructions to maximize at least one of: fuel economy of the vehicle while in transit, comfort level of the vehicle while in transit, traction of the vehicle while in transit, and tire wear on tires of the vehicle while in transit.

8. The method of claim 1, wherein the machine learning model is generated by:
performing a sensitivity analysis which identifies correlations between known values of vehicle data associated with the vehicle, known values of wheel alignment components, known driving cycles, and known vehicle applications;
forming, via a computing device, a neural network using the correlations; and
converting, via the computing device, the neural network to computer executable code, resulting in the machine learning model.

9. The method of claim 1, wherein the tire forces signal identifies:
a vertical force on at least one tire of the vehicle;
a lateral force on the at least one tire of the vehicle; and
a longitudinal force on the at least one tire of the vehicle.

10. A vehicle comprising:
at least one wheel;
at least one tire attached to the at least one wheel;
at least one tire sensor associated with the at least one wheel;
a wheel alignment controller configured to modify an alignment of the at least one wheel;
a processor;
a non-transitory computer-readable storage medium having instructions stored which, when executed by the processor, cause the processor to perform operations comprising:
receiving an optimization directive for the vehicle;
receiving, from the at least one tire sensor while the vehicle is in transit, a tire forces signal;
estimating, based at least in part on the tire forces signal, at least one aspect of vehicle performance; and
executing a machine learning model, wherein inputs to the machine learning model comprise the optimization directive and the at least one aspect of vehicle performance, and wherein outputs of the machine learning model comprise a desired wheel alignment signal; and
wherein the wheel alignment controller modifies a wheel alignment of the vehicle based at least in part on the desired wheel alignment signal.

11. The vehicle of claim 10, wherein:
the wheel alignment controller receives the tire forces signal; and
the wheel alignment controller calculates an error between a desired wheel alignment value associated with the desired wheel alignment signal and an actual wheel alignment value identified by the tire forces signal.

12. The vehicle of claim 11, wherein the operations of the processor further comprise:
modifying the machine learning model based on the error.

13. The vehicle of claim 10, wherein the machine learning model is a reinforcement learning algorithm.

14. The vehicle of claim 10, wherein the at least one aspect of vehicle performance comprises at least one of: fuel economy of the vehicle while in transit, comfort level of the vehicle while in transit, traction of the vehicle while in transit, and rate of tire wear on tires of the vehicle while in transit.

15. The vehicle of claim 10, wherein the optimization directive is provided by one of a passenger or a driver of the vehicle.

16. The vehicle of claim 10, wherein the optimization directive comprises instructions to maximize at least one of: fuel economy of the vehicle while in transit, comfort level of the vehicle while in transit, traction of the vehicle while in transit, and tire wear on tires of the vehicle while in transit.

17. The vehicle of claim 10, wherein the machine learning model is generated by:
performing a sensitivity analysis which identifies correlations between known values of vehicle data associated with the vehicle, known values of wheel alignment components, known driving cycles, and known vehicle applications;
forming, via a computing device, a neural network using the correlations; and
converting, via the computing device, the neural network to computer executable code, resulting in the machine learning model.

18. The vehicle of claim 10, wherein the tire forces signal identifies:
a vertical force on at least one tire of the vehicle;
a lateral force on the at least one tire of the vehicle; and
a longitudinal force on the at least one tire of the vehicle.

19. A non-transitory computer-readable storage medium stored within a vehicle having instructions stored which, when executed by a processor aboard the vehicle, cause the processor to perform operations comprising:
receiving an optimization directive for the vehicle;
receiving, from at least one tire sensor while the vehicle is in transit, a tire forces signal;
estimating, based at least in part on the tire forces signal, at least one aspect of vehicle performance;
executing a machine learning model, wherein inputs to the machine learning model comprise the optimization directive and the at least one aspect of vehicle performance, and wherein outputs of the machine learning model comprise a desired wheel alignment signal; and
modifying, via a wheel alignment controller, a wheel alignment of the vehicle based at least in part on the desired wheel alignment signal.

20. The non-transitory computer-readable storage medium of claim 19, wherein:
the wheel alignment controller receives the tire forces signal; and
the wheel alignment controller calculates an error between a desired wheel alignment value associated with the desired wheel alignment signal and an actual wheel alignment value identified by the tire forces signal.
